(19) United States
(12) Patent Application Publication
(10) Pub. No.: US 2002/0023957 A1
(43) Pub. Date: Feb. 28, 2002

(54) Method and apparatus for providing audio/visual feedback to scanning pen users

(76) Inventors: A. John Michaelis, Balmain (AU); James L. Warmus, LaGrange, IL (US)

Correspondence Address: MARSHALL, O'TOOLE, GERSTEIN, MURRAY & BORUN, 6300 SEARS TOWER, 233 SOUTH WACKER DRIVE, CHICAGO, IL, 60606-6402, US

(21) Appl. No.: 09/933,300

(22) Filed: Aug. 20, 2001

Related U.S. Application Data
(60) Provisional application No. 60/226,746, filed on Aug. 21, 2000.

(51) Int. Cl. G06K 7/10

(52) U.S. Cl. 235/454

(57) ABSTRACT

The method and apparatus described herein provides a system for retrieving audible and/or visual instructions stored in a machine readable code, such as a bar code. When the code is scanned by a scanning pen or other scanning device, the pen provides audible or visual feedback to the user. The feedback guides the user through a process, such as a shopping sequence, providing instructions to the next input or action. In addition, each code may also contain data indicative of a user response to a previous audio/visual prompt. Optionally, the scanning device may store an identification code which is compared to an authorization code stored in the machine readable code to determine if the user of the scanning device is authorized to see or hear certain information which is also stored in the machine readable code.

### RELATED APPLICATION

This application claims priority from U.S. Provisional Application Serial No. 60/226,746 filed Aug. 21, 2000, and which is hereby incorporated herein by reference.

### TECHNICAL FIELD

The present system relates in general to data entry using machine readable symbols, such as bar codes, and in particular to methods and apparatus for providing audio/visual feedback to scanning pen users.

### BACKGROUND

As the business of image-scanning pens and/or other image scanning systems develops, it may become important to provide audible and/or visual feedback of the scanning operation. For example, a catalog may contain scannable codes or glyphs to enable a customer to use a scanning pen to order products. The ordering process may be complex. For example, a user wishing to purchase shirts may need to specify style, size, color and quantity for each item. The scanning pen may be isolated from the Internet and other sources of information, and the pen may not have a large amount of memory. Accordingly, retrieval of audio and/or visual feedback data may be limited.

### BRIEF DESCRIPTION OF THE DRAWINGS

Features and advantages of the disclosed system will be apparent to those of ordinary skill in the art in view of the detailed description of exemplary embodiments which is made with reference to the drawings, a brief description of which is provided below.

FIG. 1 is a high level block diagram of an exemplary communications system.

FIG. 2 is a more detailed block diagram of one of the servers illustrated in FIG. 1.

FIG. 3 is a more detailed block diagram of one of the personal computers illustrated in FIG. 1.

FIG. 4 is a more detailed block diagram of one of the scanning devices illustrated in FIG. 1.

FIG. 5 is an exemplary printed page which may be used for ordering a product via the scanning device of FIG. 1.

FIG. 6 is a flowchart of a process for providing audio and/or visual feedback to a user during a shopping sequence based on audio and/or visual data encoded in a machine readable symbol.

### DETAILED DESCRIPTION OF THE PREFERRED EMBODIMENTS

In general, the system described herein retrieves audible and/or visual data stored in a machine readable code, such as a standard bar code, a two dimensional bar code, a glyph, etc. When the code is scanned by a scanning pen or other scanning device, the pen provides audible or visual feedback to the user. The feedback guides the user through a process, such as a shopping sequence, providing instructions to the next input or action. In addition, each code may also contain data indicative of a user response to a previous audio/visual prompt. For example, a single machine readable code may contain data indicative of “size=large” and “prompt=What color?”. Optionally, the scanning device may store an identification code which is compared to an authorization code stored in the machine readable code to determine if the user of the scanning device is authorized to see or hear certain information which is also stored in the machine readable code.

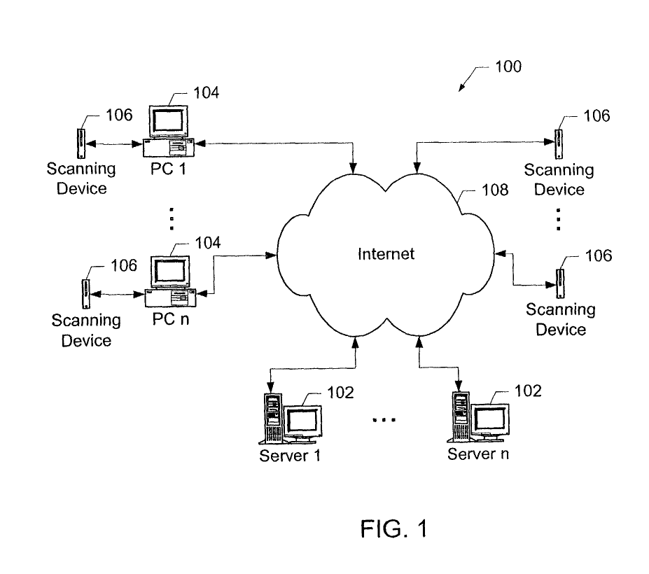

A high level block diagram of a communications system 100 providing an exemplary environment of use is illustrated in FIG. 1. The system 100 includes one or more servers 102, one or more personal computers (PCs) 104, and one or more scanning devices 106. Each of these components may communicate with each other via a connection to the Internet or some other wide area network 108. Typically, servers 102 store a plurality of files, programs, and/or web pages for use by the PCs 104 and/or scanning devices 106. One server 102 may handle requests from a large number of clients (i.e., PCs 104 and/or scanning devices 106). Accordingly, each server 102 is typically a high end computer with a large storage capacity, one or more fast microprocessors, and one or more high-speed network connections. Conversely, relative to a typical server 102, each PC 104 typically includes less storage capacity, a single medium to high-speed microprocessor, and a single medium-speed network connection.

A typical scanning device 106 includes even less storage capacity, processing power, and bandwidth capability than a typical PC 104. A scanning device 106 may be connected to the network 108 directly via a modem and/or other network interface, or a scanning device 106 may be connected to the network 108 indirectly via a PC 104 which is in turn connected to the network 108 via a modem and/or other network interface. Any of these connections may be a wired connection or a wireless connection. Often, a scanning device 106 is disconnected from the network 108 and/or the PCs 104. However, scanning operations preferably operate even when the scanning device 106 is in such a stand alone mode. In one embodiment, different users may be given pens which contain identification codes. Optionally, each identification code is unique. In this manner, different processes may be followed based on the user's identity (even if the scanned code is the same for different users). For example, a doctor's pen may produce a first set of audio and/or visual signals, while a nurse's pen produces a second set of audio and/or visual signals, even though both sets of signals are encoded in the same machine readable symbol. In addition, the identity of the person performing the scanning operation may be recorded. In this embodiment, the scanning pens may be color coded to facilitate visual identification of an associated authorization level.

Optionally, the user of a scanning pen may be required to enter a pass code in order to operate the pen at a certain authorization level. For example, a nurse may not be allowed to access doctor level codes and processes without entering a doctor's pass code. Entering a pass code may be accomplished by traditional input means or by scanning a “private” symbol. For example, a doctor may manually enter a personal identification number using a small keyboard (e.g., up/down arrows, numbers, letters, etc.) on the scanning device 106, or the doctor may scan a bar code printed on the back of his identification badge.

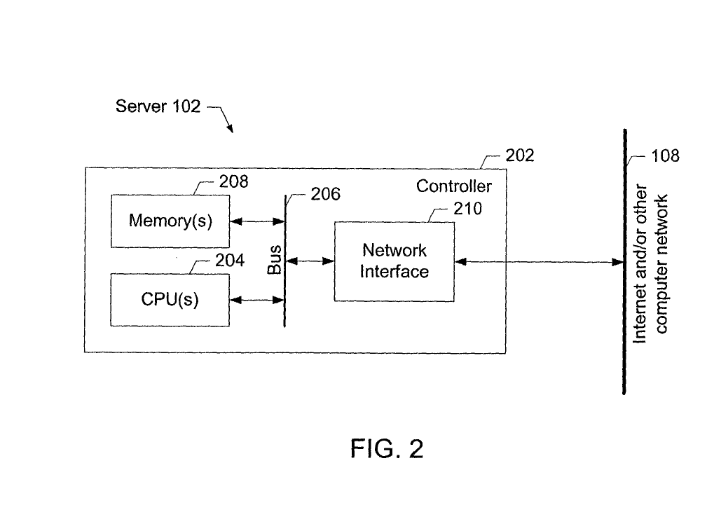

A more detailed block diagram of a server 102 is illustrated in FIG. 2. A controller 202 in the server 102 preferably includes a central processing unit 204 electrically coupled by an address/data bus 206 to a memory device 208 and a network interface circuit 210. The CPU 204 may be any type of well known CPU, such as an Intel Pentium™ processor. The memory device 208 preferably includes volatile memory, such as a random-access memory (RAM), and non-volatile memory, such as a read only memory (ROM) and/or a magnetic disk. The memory device 208 stores a software program that may implement all or part of the method described below. This program is executed by the CPU 204, as is well known. However, some of the steps described in the method below may be performed manually or without the use of the server 102. The memory device 208 also stores data, files, programs, web pages, etc. for retrieval and update by the PCs 104 and/or scanning devices 106.

The server 102 may exchange data with other computing devices via a connection to the network 108. The network interface circuit 210 may be implemented using any data transceiver, such as an Ethernet transceiver. The network 108 may be any type of network, such as a local area network (LAN) and/or the Internet.

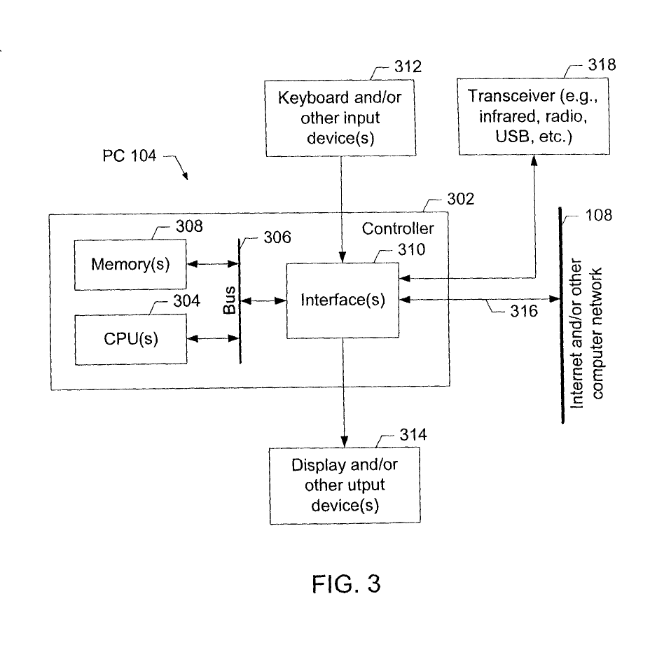

A more detailed block diagram of a PC 104 is illustrated in FIG. 3. Like the server 102, the PC 104 includes a controller 302 which preferably includes a central processing unit 304 electrically coupled by an address/data bus 306 to a memory device 308 and an interface circuit 310. Again, the CPU 304 may be any type of well known CPU, such as an Intel Pentium™ processor, and the memory device 308 preferably includes volatile memory and non-volatile memory. However, as discussed above, the CPU 304 and/or memory device 308 associated with a typical PC 104 may not be as powerful as the CPU 204 and/or memory 208 associated with a typical server 102. Like the server 102, the memory device 308 associated with the PC 104 stores a software program that may implement all or part of the method described below. This program is executed by the CPU 304, as is well known. However, some of the steps described in the method below may be performed manually or without the use of the PC 104. The memory device 308 also stores data, files, programs, web pages, etc. retrieved from a server 102 and/or transmitted by a scanning device 106.

The interface circuit 310 may be implemented using any type of well known interface standard, such as an Ethernet interface and/or a Universal Serial Bus (USB) interface. One or more input devices 312 may be connected to the interface circuit 310 for entering data and commands into the controller 302. For example, the input device 312 may be a keyboard, mouse, touch screen, track pad, track ball, isopoint, and/or a voice recognition system. One or more output devices 314 may also be connected to the controller 302 via the interface circuit 310. Examples of output devices 314 include cathode ray tubes (CRTs), liquid crystal displays (LCDs), speakers, and/or printers. The output device 314 generates visual displays of data generated during operation of the PC 104. The visual displays may include prompts for human operator input, run time statistics, calculated values, detected data, etc.

The PC 104 may also exchange data with other computing devices via a connection 316 to the network 108 and/or a direct connection data transceiver 318. The network connection 316 may be any type of network connection, such as an Ethernet connection, digital subscriber line (DSL), telephone line, coaxial cable, etc. The data transceiver 318 may be any type of data transceiver, such as an infrared transceiver, a radio transceiver, a Universal Serial Bus transceiver (USB), etc.

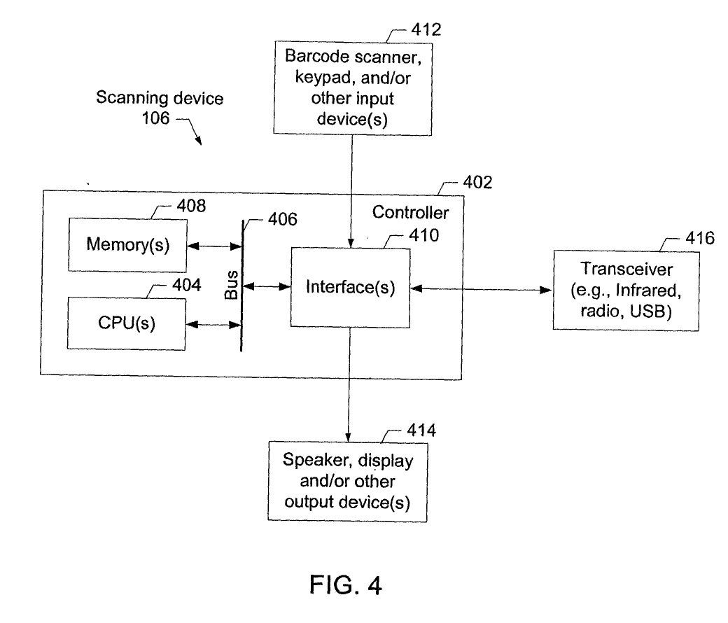

A more detailed block diagram of a scanning device 106 is illustrated in FIG. 4. The scanning device 106 also includes a controller 402 which preferably includes a central processing unit 404 electrically coupled by an address/data bus 406 to a memory device 408 and an interface circuit 410. Although, the scanning device CPU 404 may be any type of well known CPU, typically the scanning device CPU 404 is less powerful than the PC CPU 304 and the server CPU 204. Similarly, the scanning device memory 408, which preferably includes volatile and non-volatile memory, is not as large as the PC memory device 308 and the server device 208. Like the server 102 and PC 104, the scanning device memory 408 stores a software program that may implement all or part of the method described below. This program is executed by the CPU 404, as is well known. However, some of the steps described in the method below may be performed manually or without the use of the scanning device 106. The memory device 408 may also store an identification code, authorization codes, pass codes, input data, audio data, and/or visual data. Data stored in memory 408 may be retrieved from a machine readable symbol, retrieved from a server 102, retrieved from a PC 104 and/or stored during the manufacture or setup of the scanning device 106.

The interface circuit 410 may be implemented using any data transceiver, such as an infrared transceiver, a radio transceiver, an Ethernet transceiver, and/or a Universal Serial Bus (USB) transceiver. One or more input devices 412 are connected to the interface circuit 410 for entering data and commands into the controller 402. In the preferred embodiment, the input device 412 includes a small number of keys and a bar code reader.

One or more output devices 414 are connected to the scanning device controller 402 via the interface circuit 410. Preferably the scanning device 106 includes a liquid crystal display and/or a speaker. The output device 414 generates visual displays and/or audio of data retrieved and/or generated during operation of the scanning device 106. The visual displays and audio generated may include prompts for human operator input, run time statistics, calculated values, detected data, etc.

A data transceiver 416 allows the scanning device 106 to exchange data with a PC 104. For example, after receiving purchase data by scanning one or more bar codes, the scanning device 106 may upload the purchase data to a PC 104 for subsequent transfer to a server 102 which fulfills the order. The data transceiver 416 may be any input/output device such as an infrared transceiver, radio transceiver, serial connection, parallel connection, etc. In addition, the scanning device 106 may also exchange data with other computing devices via a connection to the network 108. The connection may be any type of network connection, such as an Ethernet connection, digital subscriber line (DSL), telephone line, coaxial cable, etc.

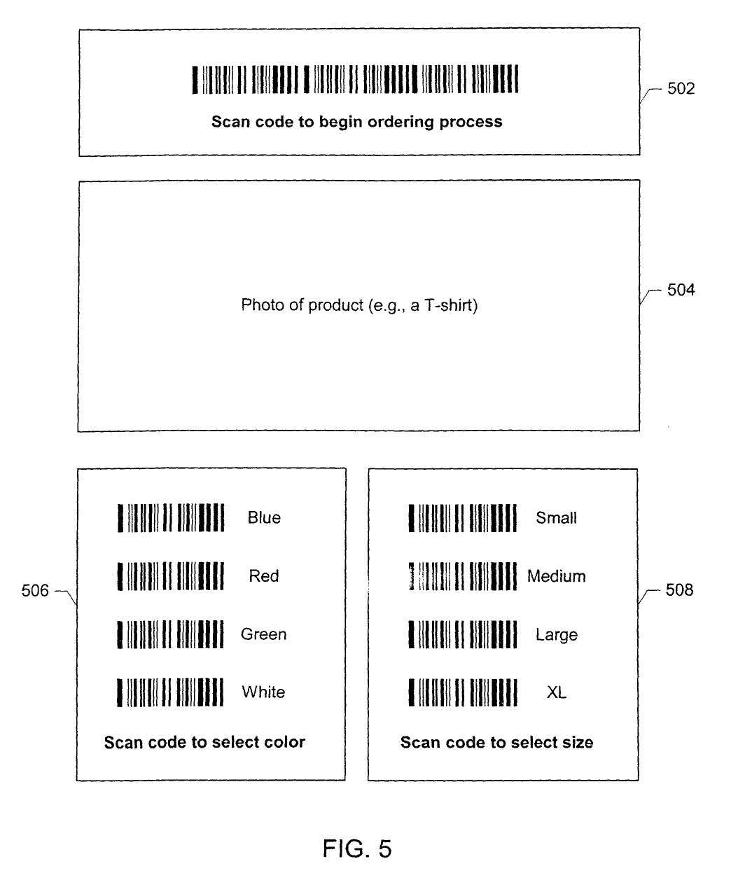

An exemplary printed page, which may be used for ordering a product via a scanning device 106, is illustrated in FIG. 5. In this example, a first bar code 502 begins the ordering process. The data encoded in this first bar code preferably includes a first portion which identifies the product as shown in an optional product photo 504 and a second portion which defines audio arid/or visual information which prompts the user for one or more subsequent inputs. For example, the first portion may be “SKU=1234ABCD” to identify a particular brand and style of T-shirt. The second portion may be digitized audio and/or text for “select a color” and/or “select a size.”

In addition, the first bar code may include a third portion which enumerates the type and/or amount of data that is required to complete the data acquisition process for this product. Alternatively, a single bar code may be used to specify a complete order. For example, the photo 504 and descriptive text accompanying the photo 504 may specify a brand, style, size, color, quantity, etc. In such an instance, an associated bar code may represent everything that is needed to order the product.

Alternatively, a bar code may be indicative of a “style sheet.” The style sheet defines a predetermined sequence of data to be scanned. For example, if every product ordering sequence in a particular catalog consists of scanning a product type, followed by a product size, followed by a product color, the user may scan a code on the front of the catalog which indicates the “product-size-color” style sheet is to be used. Text and/or audio prompts for style sheet entry may be preprogrammed into the scanning device 106. In this manner, the data for the prompts need not be stored in the machine readable symbols. In addition, certain default values may be included. For example, if the scanning device detects a new product scan without receiving a color scan, a default color and/or an error message may be used.

Other bar codes 506, 508 may be used to enter the additional data (e.g., color, size, etc.). Each of these bar codes 506, 508 may also include portions which define audio and/or visual information prompting the user for additional inputs. In this manner, the user may be led through the ordering process. Of course, a person of ordinary skill in the art will readily appreciate that processes other than ordering products may be employed. For example, data entry of a predefined form may be performed (e.g., a survey, a medical form, etc.). In addition, the user may enter certain data in a traditional manner. For example, quantities may be entered via a numeric keypad, or colors may be indicated by two letter abbreviations.

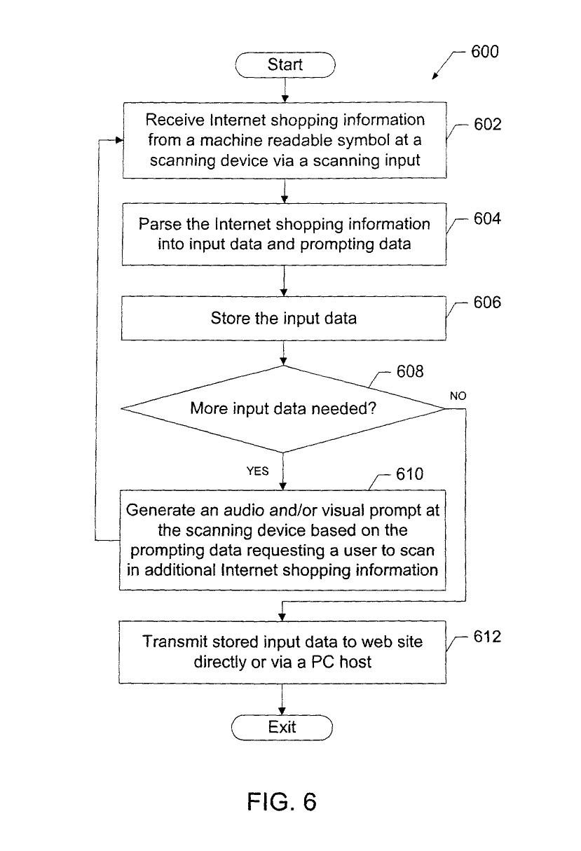

A flowchart of a process 600 for providing audio and/or visual feedback to a user during a shopping sequence (or other sequence) based on audio and/or visual data encoded in a machine readable symbol is illustrated in FIG. 6. Preferably, the process 600 is executed by the scanning device CPU 404 as is well known. However, one or more of the steps described below may be performed in conjunction with another device, a user, and/or without the use of a CPU. Generally, the process 600 receives shopping data and/or other information from one or more machine readable codes. In addition, the process receives prompting data from the machine readable codes. The prompting data is used to generate audio and/or visual prompts to aide the user. Subsequently, the shopping data is transmitted to a web site which fulfills the indicated purchase request.

The process 600 begins by receiving Internet shopping information (or other information) via the scanner 412 from a machine readable symbol, such as a bar code symbol (step 602). The Internet shopping information is then parsed into input data, prompting data, and/or other data (step 604). Input data includes user selections such as product identifiers, quantities, etc. Prompting data includes audio and/or visual data used to prompt and/or aide the user. Other data may include termination data such as the number and/or type of input data entries required. Although all of this data is preferably stored in memory 408 at least temporarily, the input data in particular is accumulated for subsequent transmission (step 606).

If more input data is needed (step 608), the process uses the prompting data to generate audio and/or visual prompts at the speaker and/or display 414 of the scanning device 106 (step 610). Preferably, the prompt requests the user to scan another symbol to enter additional Internet shopping information. If a complete set of input data is acquired (step 608), the process 600 transmits the stored input data to a web site (step 612). The transmission may be performed directly by the scanning device 106 or indirectly via a PC 104. In a preferred embodiment, the scanning device 106 transmits the stored input data to a server 102 via a PC 104 when the scanning device 106 is cradled in a device connected to the PC 104 or when the scanning device 106 is brought within transmitting range of the PC 104 (e.g., using infrared or radio signals).

Preferably, the Internet address of the web site server 102 is included in a scanned symbol. However, in an alternate embodiment, the scanning device 106 and/or the PC 104 is preprogrammed with a centralized web site address. The server 102 located at the centralized address and/or the PC 104 then determines the ultimate web site address. In this manner, multiple vendors may be used without the need to include web site addresses in the machine readable symbols.

In summary, persons of ordinary skill in the art will readily appreciate that a method and apparatus for providing audio/visual feedback to scanning pen users has been provided. Systems implementing the teachings described herein can utilize audio and/or visual feedback provided to a user during a shopping sequence (or other sequence) based on audio and/or visual data encoded in a machine readable symbol.

The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of exemplary embodiments, but rather by the claims appended hereto.

What is claimed is:

1. An apparatus for scanning a machine readable symbol and providing an audio feedback signal stored in the machine readable symbol to a user, the apparatus comprising:
an input device capable of detecting the machine readable symbol and generating an electrical signal indicative of the machine readable symbol;
a controller operatively coupled to the input device for receiving the electrical signal indicative of the machine readable symbol;
a memory device operatively coupled to the controller, the memory device storing a digital representation of the electrical signal indicative of the machine readable symbol; and
a speaker operatively coupled to the controller, the controller causing the speaker to generate the audio feedback signal from the digital representation of the electrical signal indicative of the machine readable symbol.

2. An apparatus as defined in claim 1, wherein the input device comprises an optical code scanner.

3. An apparatus as defined in claim 2, wherein the optical code scanner includes an identification code, the controller causing the speaker to generate the audio feedback signal only if the identification code matches a predetermined identification code.

4. An apparatus as defined in claim 3, wherein the controller causes the speaker to generate an alternate audio feedback signal if the identification code matches an alternate identification code, the alternate audio feedback signal being derived from the digital representation of the electrical signal indicative of the machine readable symbol.

5. An apparatus as defined in claim 3, wherein the optical code scanner is color coded based on the identification code.

6. An apparatus as defined in claim 3, wherein the optical code scanner includes a first pass code, the controller receiving a second pass code, the controller causing the speaker to generate the audio feedback signal only if the first pass code matches the second pass code.

7. An apparatus as defined in claim 6, wherein the second pass code is received via the input device capable of detecting the machine readable symbol.

8. An apparatus as defined in claim 6, further comprising a keypad operatively coupled to the controller, wherein the second pass code is received via the keypad.

9. An apparatus as defined in claim 1, further comprising a visual display operatively coupled to the controller, the controller causing the visual display to display a first visual prompt, the first visual prompt requesting product identification information, the controller being structured to parse the digital representation of the electrical signal indicative of the machine readable symbol into the requested product identification information and visual data, the controller being structured to cause the visual display to display a second visual prompt based on the visual data.

10. An apparatus as defined in claim 9, wherein the input device includes an identification code, the controller causing the visual display to display the second visual prompt only if the identification code matches a predetermined identification code.

11. An apparatus as defined in claim 10, wherein the controller causes the visual display to display a third visual prompt if the identification code matches an alternate identification code.

12. A method of providing an audio feedback signal to a scanning pen user, the method comprising the steps of:
receiving a first electrical signal indicative of a machine readable symbol, the machine readable symbol storing the audio feedback signal;
converting the electrical signal into a digital code, at least a portion of the digital code being indicative of the audio feedback signal;
causing a speaker to produce the audio feedback signal based on the at least a portion of the digital code.

13. A method as defined in claim 12, wherein the step of receiving a first electrical signal indicative of a machine readable symbol comprises the step of receiving an optical code signal.

14. A method as defined in claim 12, further comprising the steps of:
reading an identification code stored in a scanning pen;
parsing an authorization code from the converted digital code; and
determining that the identification code matches the authorization code.

15. A method as defined in claim 12, further comprising the steps of:
reading a first pass code stored in a scanning pen;
receiving a second pass code; and
determining that the first pass code matches the second pass code.

16. A method as defined in claim 15, wherein the step of receiving a second pass code comprises the step of optically scanning a pass code symbol.

17. A method as defined in claim 12, further comprising the step of optically scanning a style sheet code.

18. A method as defined in claim 12, further comprising the steps of:
displaying a first visual prompt requesting product identification information;
parsing the digital code into the requested product identification information and visual data;
displaying a second visual prompt based on the visual data.

19. A method as defined in claim 18, further comprising the steps of:
reading an identification code stored in a scanning p en;
parsing an authorization code from the converted digital code; and
determining that the identification code matches the authorization code.

20. A method of facilitating an Internet shopping sequence, the method comprising the steps of:
prompting a user, via a first visual prompt, to enter first information associated with the Internet shopping sequence, the first visual prompt being displayed on a portable symbol scanning device;
receiving data indicative of a machine readable symbol at the portable symbol scanning device; and
parsing the data indicative of the machine readable symbol into the first information and a second visual prompt.

21. A method as defined in claim 20, further comprising the step of causing a speaker to produce an audio feedback signal based on the data indicative of the machine readable symbol.

22. A method as defined in claim 21, further comprising the steps of:
reading an identification code stored in the portable symbol scanning device;
parsing an authorization code from the data indicative of the machine readable symbol; and
determining that the identification code matches the authorization code.

23. A method as defined in claim 21, further comprising the steps of:
reading a first pass code stored in the portable symbol scanning device;
receiving a second pass code; and
determining that the first pass code matches the second pass code.

24. A method as defined in claim 23, wherein the step of receiving a second pass code comprises the step of optically scanning a pass code symbol.

25. A method as defined in claim 21, further comprising the step of optically scanning a style sheet code.

26. An apparatus for facilitating an Internet shopping sequence, the apparatus comprising:
a visual display structured to generate a plurality of visual prompts;
a scanner structured to convert a machine readable symbol into symbol data; and
a controller operatively coupled to the visual display and the scanner, the controller being structured to cause the visual display to display a first visual prompt, the first visual prompt requesting product identification information, the controller being structured to receive the symbol data from the scanner, the controller being structured to parse the symbol data into the requested product identification information and visual data, the controller being structured to cause the visual display to display a second visual prompt based on the visual data.

27. An apparatus as defined in claim 26, wherein the controller is further structured to:
read an identification code stored in the scanner;
parse an authorization code from the symbol data; and
determine that the identification code matches the authorization code.

28. An apparatus as defined in claim 26, further comprising a speaker operatively coupled to the controller, the controller being structured to cause speaker to produce an audio feedback signal based on the symbol data.

29. An apparatus as defined in claim 28, wherein the controller is further structured to:
read an identification code stored in the scanner;
parse an authorization code from the symbol data; and
determine that the identification code matches the authorization code.

30. A method of facilitating an Internet shopping sequence, the method comprising the steps of:
prompting a user, via a first audio prompt, to enter first information associated with the Internet shopping sequence, the first audio prompt being generated by a portable symbol scanning device;
receiving data indicative of a machine readable symbol at the portable symbol scanning device; and
parsing the data indicative of the machine readable symbol into the first information and a second audio prompt.

31. A method as defined in claim 30, further comprising the step of displaying a visual feedback signal based on the data indicative of the machine readable symbol.

32. An apparatus for facilitating an Internet shopping sequence, the apparatus comprising:
a speaker structured to generate a plurality of audio prompts;
a scanner structured to convert a machine readable symbol into symbol data; and
a controller operatively coupled to the speaker and the scanner, the controller being structured to cause the speaker to produce a first audio prompt, the first audio prompt requesting product identification information, the controller being structured to receive the symbol data from the scanner, the controller being structured to parse the symbol data into the requested product identification information and audio data, the controller being structured to cause the speaker to produce a second audio prompt based on the audio data.

33. An apparatus as defined in claim 32, further comprising a display device operatively coupled to the controller, the controller being structured to cause display device to produce a visual feedback display based on the symbol data.
